(19) United States
(12) Patent Application Publication
(10) Pub. No.: US 2018/0114659 A1
(43) Pub. Date: Apr. 26, 2018

(54) MECHANICAL HEAT SWITCH AND METHOD

(71) Applicant: BASF SE, Ludwigshafen (DE)

(72) Inventors: David Eric SCHWARTZ, San Carlos, CA (US); Yunda WANG, Milpitas, CA (US); Scott LIMB, Palo Alto, CA (US); Sean GARNER, San Francisco, CA (US); Sylvia SMULLIN, Menlo Park, CA (US); James ZESCH, San Cruz, CA (US); Craig ELDERSHAW, Belmont, CA (US); David JOHNSON, San Francisco, CA (US); Martin SHERIDAN, Redwood City, CA (US)

(73) Assignee: BASF SE, Ludwigshafen (DE)

(21) Appl. No.: 15/562,954

(22) PCT Filed: Mar. 21, 2016
(86) PCT No.: PCT/EP2016/056077

§ 371 Date: Sep. 29, 2017

Related U.S. Application Data
(60) Provisional application No. 62/140,274, filed on Mar. 30, 2015.
(60) Provisional application No. 62/202,940, filed on Aug. 10, 2015.

(51) Int. Cl. H01H 61/01; H01H 37/02

(52) U.S. Cl. CPC H01H 61/01; F28F 13/18; H01H 37/02

(57) ABSTRACT

A first structure has alternating fingers of first and second materials, the first material having a higher thermal conductivity than the second material, a second structure has alternating fingers of third and fourth materials, positioned to selectively contact the first structure, and an actuator connected to move the second structure. A method of manufacturing a heat switch includes forming a first structure in a first material having finger separated from each other by gaps, forming a second structure in the first material having fingers at least partially separated from each other by gaps, positioning the first and second structure adjacent to and in contact with each other, and connecting the second structure to an actuator. A method of operating includes receiving an activation signal at an actuator, and using the actuator to move one structure relative to another structure to change alignment between two regions of different thermal conductivity.

### TECHNICAL FIELD

This disclosure relates to heat or thermal switches, more particularly to mechanical heat or thermal switches.

### BACKGROUND

Heat switches, also referred to here as thermal switches, are devices with a thermal conductance switchable between at least two values. In a typical use, these switches switch between a relatively low thermal conductance and a relatively high thermal conductance path. In the high conductance state, heat transfers more easily through the device than in the low conductance state. Such a device may be used for variable insulation, selective heating or cooling, or as part of an electrocaloric, magnetocaloric, or other heat pumping or cooling system. While the optimal parameters for a heat switch vary from application to application, in general it is desirable to achieve a high ratio between the high and low conductance values. In some applications, it is important for the high conductance to have a high level above a particular value, or for the low conductance to have a low level below a certain level.

Many variations of heat switches have been described in the current art. Heat, or thermal, switches used in cooling systems is described in U.S. Pat. No. 4,136,525 and its many foreign counterparts. Some systems employ electrocaloric heating systems in which a material changes temperature in response to an applied electric field. PCT Published application WO2006056809 describes such a system. Other systems may employ arrays of heat switches, such as in U.S. Pat. No. 8,659,903, that connect a passive cooling device to a path of high thermal conductivity.

Some heat switches employ liquid crystal material as described in US Patent Publication Nos. 20100175392, 201000037624, and 20130074900; PCT published applications WO2009126344, and WO2009128961; and U.S. Pat. No. 9,252,481. The material changes its alignment in response to electrical stimuli, thereby changing its thermal conductivity. This material does not have a very high contrast ratio, the difference between the low conductance state and the high conductance state.

Other switches use solid state switching. Some use magnetically or electrostatically activated micro-electromechanical systems (MEMS). These may involve a MEMS arm or actuator, such as described in US Patent Publication No. 20130141207, and U.S. Pat. No. 6,429,137. Other switches may use solid state thermal switches as those disclosed in U.S. Pat. No. 6,429,137. Yet another option involves moving droplets of liquid into and out of the heat path, such as in US Patent Publication No. 20130126003.

These switches have various issues, such as lower contrast ratios, difficulty in manufacturing, or high complexity and cost of manufacturing. Efficient heat switches should have high contrast ratios, at least 20 or higher, simplicity of actuation, and scalability to larger and smaller areas.

### SUMMARY

An embodiment includes a heat switch having a first structure having alternating fingers of first and second materials, wherein the first material has a higher thermal conductivity than the second material, a second structure having alternating fingers of third and fourth materials, positioned adjacent the second structure such that the second structure selectively contacts the first structure, and an actuator connected to one of the first and second structures such that when the actuator is activated, at least the second structure moves relative to the other of the first and second structures.

Another embodiment is a method of manufacturing a heat switch, including forming a first structure in a first material, the first structure having fingers at least partially separated from each other by gaps, forming a second structure in the first material, the second structure having fingers at least partially separated from each other by gaps, positioning the first and second structure adjacent to and in contact with each other, and connecting the second structure to an actuator.

Another embodiment is a method of operating a heat switch having two structures, including receiving an activation signal at an actuator, and using the actuator to move one structure of the heat switch relative to another structure of the heat switch to change alignment between two regions of different thermal conductivity, wherein the first and second structures have both regions of different thermal conductivity.

### BRIEF DESCRIPTION OF THE DRAWINGS

FIGS. 1 and 2 show an embodiment of a heat switch.

FIGS. 3 and 4 show an alternative embodiment of a heat switch.

FIG. 5 shows a top view of an embodiment of one structure in a heat switch.

FIGS. 6 and 7 show alternative embodiments of a heat switch.

FIG. 8 shows an embodiment of an assembled heat switch.

FIGS. 9 and 10 show an embodiment of a heat switch with internal bumpers.

FIGS. 11 and 12 show an embodiment of a heat switch with external bumpers.

FIGS. 13 and 14 show an embodiment of a heat switch with internal alignment structures.

FIGS. 15 and 16 show an embodiment of a heat switch with external alignment structures.

FIGS. 17-19 shows views of an alternative embodiment of a heat switch having grooves and spheres.

FIG. 20 shows an embodiment of a heat switch having a raised rail.

FIG. 21 shows a side view of an embodiment of a heat switch having capping.

FIGS. 22-24 shows views of an embodiment of a rotary heat switch.

FIG. 25 and FIG. 26 show embodiments of a heat switch.

FIG. 27 shows a scheme of the operation principle of a heat switch based electrocaloric cooling system.

FIG. 28 shows a possible arrangement of heat switches and electrocaloric material in an electrocaloric cooling device.

### DETAILED DESCRIPTION OF THE EMBODIMENTS

The following discussion focuses on a mechanical heat switch composed of at least two structures. ‘Heat switch’ as that term is used here means a device with a thermal conductance that can switch between at least two values. ‘High’ thermal conductance or conductivity and low′ thermal conductance or conductivity are relative terms, in which one value of thermal conductivity is higher than the other. The term ‘structure’ as used here means one part of a mechanical heat switch that, when combined with at least one other part, forms the heat switch. A ‘support’ consists of any component to which one of the structures may attach.

FIG. 1 shows an embodiment of a heat switch. The heat switch 10 has at least two structures, possibly referred to here as part A and part B. The structure 12, which may be referred to as part A, in this embodiment consists of alternating fingers of materials, a first higher thermal conductivity material 20 and a second lower thermal conductivity material 22. The structure 14, which may be referred to as part B, is similarly arranged with alternating fingers or regions of the high thermal conductivity material 20 and the low thermally conductivity material 22. The switch is in the ‘on’ state when the high thermal conductivity materials are aligned, making the on state being the high thermal conductance state. The switch is in the ‘off’ state when the high thermal conductivity material on one part is aligned with the low thermal conductivity material on the other part.

The ‘fingers’ may be connected to a base portion, may be single fingers attached to a support such as 18, or alternating regions on a substrate. The support is optional and may or may not be necessary depending upon the structure of the fingers. If a support is included, having the support manufactured from a high thermal conductivity material assists with the performance of the heat switch. The fingers and support may consist of one material in a monolithic piece. In between the two structures 12 and 14 is an optional layer of lubricant 16 that allows the two parts to move relative to each other. Both parts may move, or one may move with the other being fixed. The lubricant layer may consist of a coating on the fingers. In some embodiments, as will be discussed later, only the fingers of the high thermal conductivity material have the coating. Generally, thinner layers of the lubricant are preferred. The thermal conductivity of the lubricant is often lower than the high conductivity material. If it were to have a significant thickness, it would decrease the thermal conductance of the switch in the on state. The viscosity of the lubricant has an effect on the ease of the actuation, and lower viscosity may be preferable in many embodiments. The lubricant may have particles added to it to increase its thermal conductivity and/or to maintain separation between the two structures.

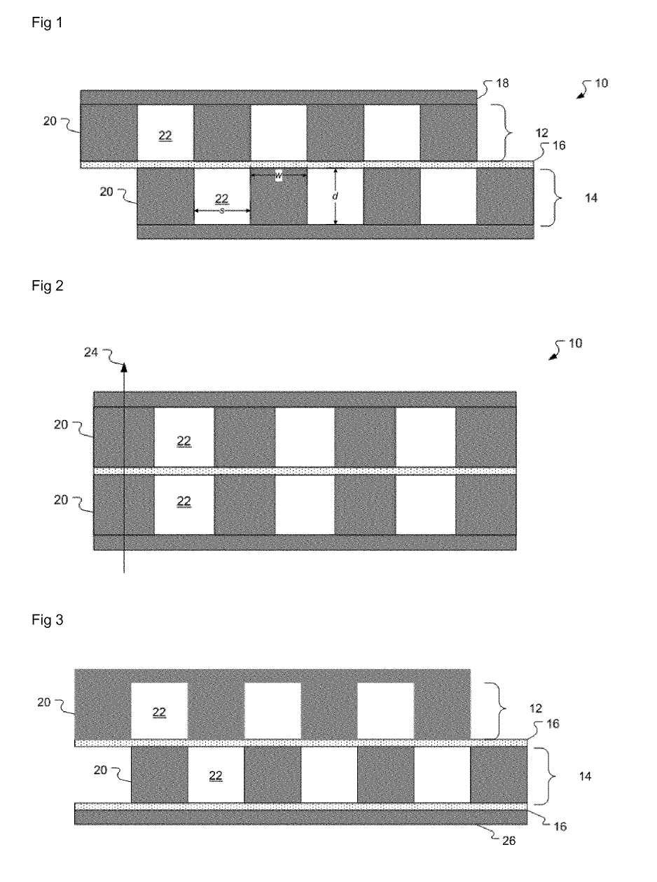

In operation, one or the other structure moves relative to the other. In the off state, as shown in FIG. 1, the high thermally conductivity material 20 is adjacent to the low thermal conductivity material 22. Any heat transferred from any item adjacent to the switch through the high thermal conductivity material 20 flows into the low thermal conductivity material 22, which impedes the heat transfer through the switch. In FIG. 2, one of the components moves relative to the other to align the high and low thermal conductivity regions with each other. As shown by the path 24, heat now can flow more easily from one side of the switch to the other through the high thermal conductivity material. The other side of the switch may contact a heat sink or other type of heat removal component.

In each of the structures 12 and 14, the high thermal conductivity material has a width wand the low thermal conductivity material has a width s, with the understanding that the dimensions s and w may be different for each structure. The dimension s may or may not equal w, and if they are not equal, the switch will typically function better if s is somewhat larger than w so that, in the off state, there is lateral space between the high conductivity regions of the two parts, reducing the overall thermal conductance and increasing the tolerance to misalignment. The height of each part may be referred to as the variable d, where again the actual dimension may vary and the two parts may have different heights. If s is larger than w, when the switch is in the off position the high thermal conductivity material should center on the low thermal conductivity region on the opposite part, but need not do so exactly. The two structures may or may not be identical.

The actual dimensions on the heat switch will depend upon the application. The actuation distance to switch between the on and off states is approximately 0.5(w+s) and is constrained by the capability of the actuator and the application. The relative values of the finger widths wand s depend upon the materials used and the presence or absence of an overlap support structure. In general, s≥w, for example s=1.5 w. When all else is equal, in many embodiments, lower ratios of s to w lead to higher switch conductance in the off state and also higher on conductance.

The material with high thermal conductivity may consist of many different types of materials, including silicon, copper, aluminum, or other metals, semi-metals, semiconductors, and ceramics. Examples include boron nitride (BN), aluminum nitride (AlN), and diamond. The material should be fairly rigid. In order to facilitate a very thin space between the two parts, the surfaces on the two structures should be flat and smooth. Silicon wafers have high thermal conductivity and flatness characteristics. They can also be easily micromachined or etched. The fingers may be formed from by machining or micromachining. Similarly, metals can be polished to be very smooth and machined to have very precise features.

The material with low thermal conductivity could consist of a solid, a liquid, a gas, such as air, or a vacuum. In one embodiment, the low thermal conductivity material could be air, such that the structures may be formed of a high thermal conductivity material with fingers of the material having gaps between them. Options for solid materials include porous silicon, epoxy, porous epoxy, polyimide, polyurethanes, porous polyurethanes, aeorgels and photoresist among many others. If the low thermal conductivity material is added to the high thermal conductivity material, polishing may improve the flatness and smoothness.

Another option for the low conductivity material involves the use of curable liquids, such as an epoxy, applied to the surface with a doctor blade or other smoothing technique. The surfaces of the fingers may be pre-treated with an anti-wetting agent to reduce wetting. Multiple applications may need to achieve flatness. Porous silicon has an advantage of being intrinsically fabricated on a silicon part. Porous epoxies have the advantage of extremely low thermal conductivities. The selection of the material will depend upon the nature of the application.

Options for the lubricant include silicone oils, mineral oils, and ethylene glycol. One embodiment uses silicone oils of 5-100 cPs. The switch will have improved thermal performance by increasing the thermal conductivity of the lubricant. Many higher thermal conductivity liquids contain highly thermally conductive particles that also tend to increase the viscosity and abrasiveness of the fluid. The particles may also act as spacer and help to avoid wringing out of the lubricant with repeated cycling. However, adding smaller loadings of solid microspheres or other shapes to the lubricant may reduce or avoid abrasion during actuation. It is preferred to use particles made of materials which are softer than the materials used for making the heat switch. The microspheres or particles may consist of polystyrene or other relatively soft material. Other options include silver and metal microparticles. In some embodiments, the heat switch surface may be treated or coated to enhance wetting by the lubricant. This can enable a thinner lubricant layer. The treatment or coatings may be applied through oxidation, plasma, atomic layer deposition (ALD), physical vapor deposition (PVD), or chemical vapor deposition (CVD), or other means as appropriate to the coating. Silicone oils naturally wet silicon so no additional coating is required. Solid lubricants, such as diamond-like-carbon coatings, are also possible, though they may lead to lower contact thermal conductance between the parts.

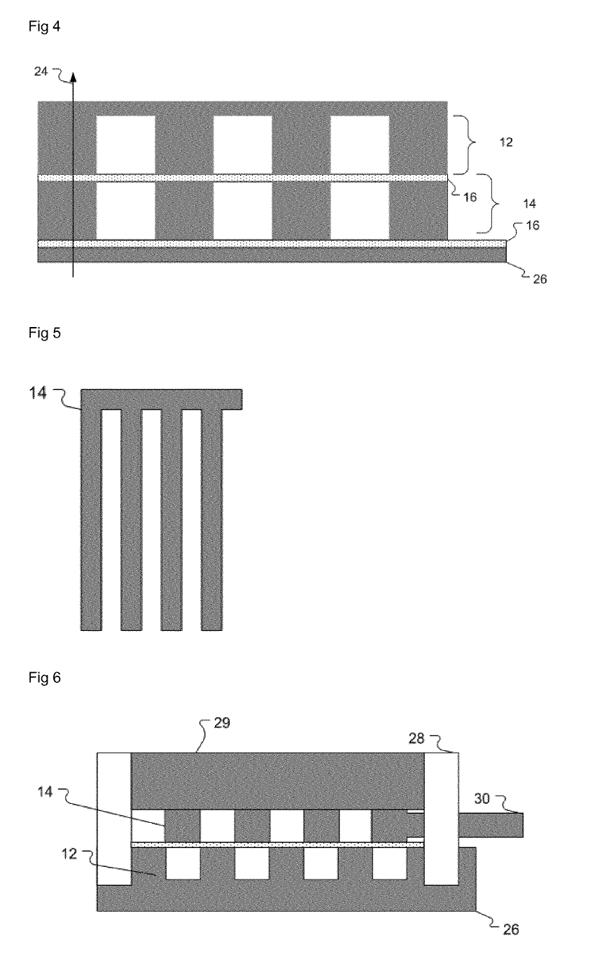

Many variations of this device exist. In FIGS. 3 and 4, for example, an embodiment has one structure of the heat switch attached to another structure 26, which may or may not be one of the supports previously mentioned. This embodiment has the advantage of having stationary outer features, 12 and 26, facilitating integration into a system. The structure 14, referred to as part B, has its thermally conductive regions offset from the thermally conductive regions on structure 12, also called part A. The thermal switch is off. In FIG. 4, part B has moved, causing the high thermal conductivity regions to align. As can be seen in FIG. 4, part A has not moved, but part B has moved along the structure 26. FIG. 5 shows a top view of the part B, 14. The voids between the fingers could be filled with low thermal conductivity material, a gas, liquid or solid, or a vacuum. In some embodiments part 14 may be held in close proximity to part 26 by the surface tension of the lubricant.

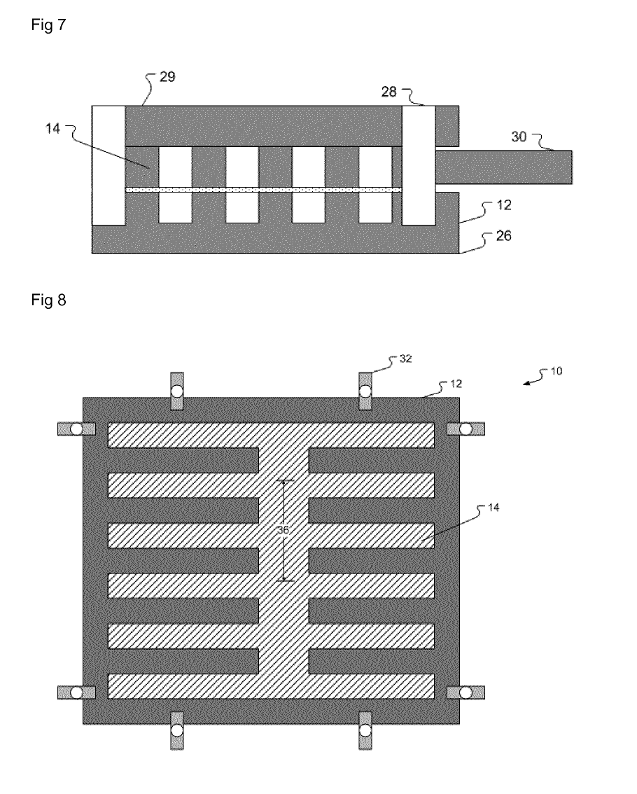

FIGS. 6 and 7 show a side view of an embodiment of the switch having one structure fixed to another structure with a moving structure in between. Part A, 12, is attached to the bottom structure 26 by struts or braces 28. Actuator arm 30 is connected to part B, 14, and an actuator. A flat plat 29 is fixed relative to the part 12, and the teeth of part 14 move with the actuator 30.

The actuator arm 30 attaches to some sort of actuator. Examples include a linear actuator, such as a voice coil, linear motor, comb drive, piezoelectric actuator, or a rotational actuator connected to a cam. Upon an activation of some sort, the actuator 30 causes part B to move causing the thermally conductive regions on parts A and B to align, as shown in FIG. 7. While the embodiments shown in FIGS. 6 and 7 show one particular attachment, the attachment arm may attach to the heat switch from the top or the side.

The moving part of the heat switch may have a handle attached as a connection to the actuator. The handle may be flexible. The actuator or the handle may be attached with a flexure, spring, or other compliant mechanism, a rigid connector, ball, ball-in-shroud, or other mechanism that reduces the number of dimensions in which force is transferred between the actuator and heat switch. The thermal path between the heat switch and the actuator should be taken into account and may be designed to minimize the thermal coupling between the two, e.g. by using a thermally low conductivity material for attaching actuator and heat switch for example glass. The actuator may intrinsically have the capability of controlling its position and extent. A feedback system may provide this. The actuator determines the on and off positions of the heat switch. If the actuator does not have the ability to control its position, or cannot do so with enough precision, restraints in the forms of bumpers or pins may control its position to avoid overshooting. FIG. 8 shows a top view of the switch 10. Part A, 12 is fixed and part B moves in the direction as shown. The holes such as 32 may hold stopper pins at either end of the direction of movement, or may keep things in alignment perpendicular to the motion.

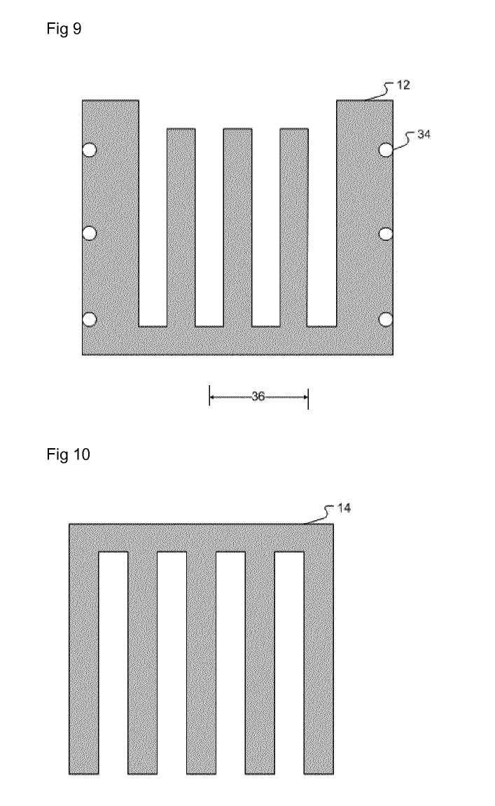

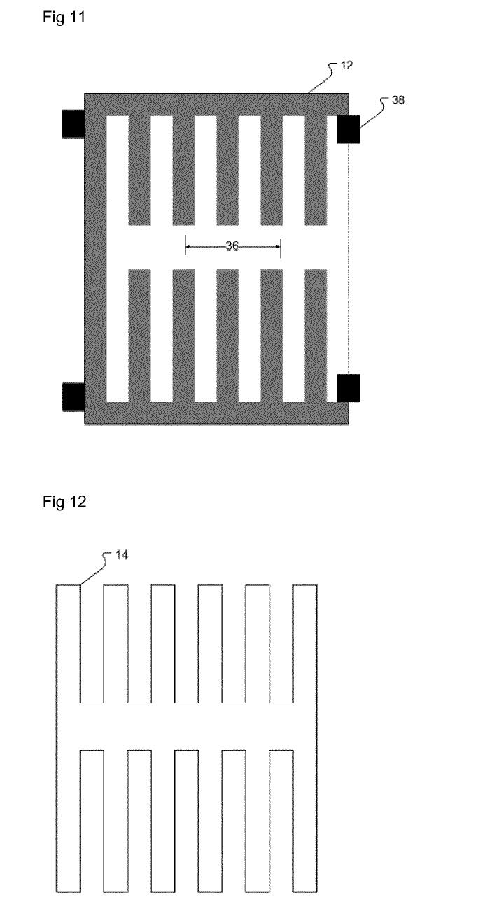

FIG. 9 shows an example of an ‘internal’ restraint, where the restraint in within the structure to control the motion of the moving part. In FIG. 9, etched holes such as 34 reside within the boundaries of the non-moving part 12 and may contain stopper pins. The moving part 14 shown in FIG. 10 will move as shown in the direction of arrow 36 once it is positioned with the non-moving part 12. Alternatively, part 12 may be actuated, while part 14 is stationary. FIG. 11 shows an embodiment of external restraints in the direction of motion of the switch. The external bumpers or stoppers 38 prevent the moving part B from overshooting upon actuation. FIG. 12 shows the part B 14 that combined together with part A 12 makes the thermal switch.

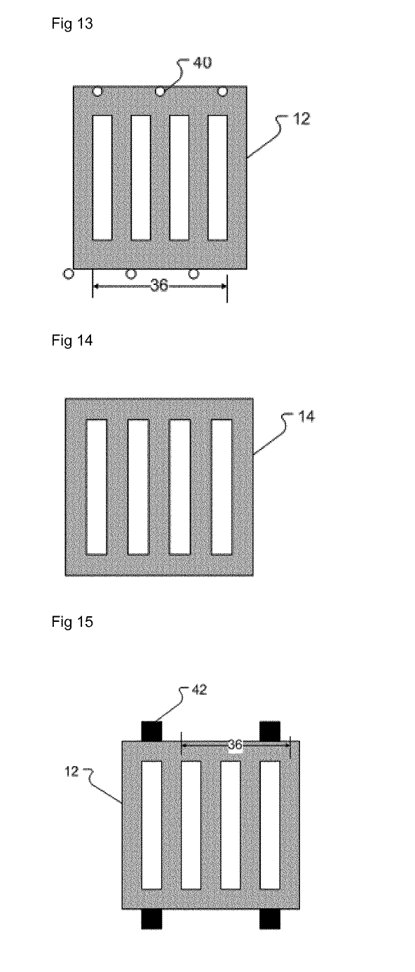

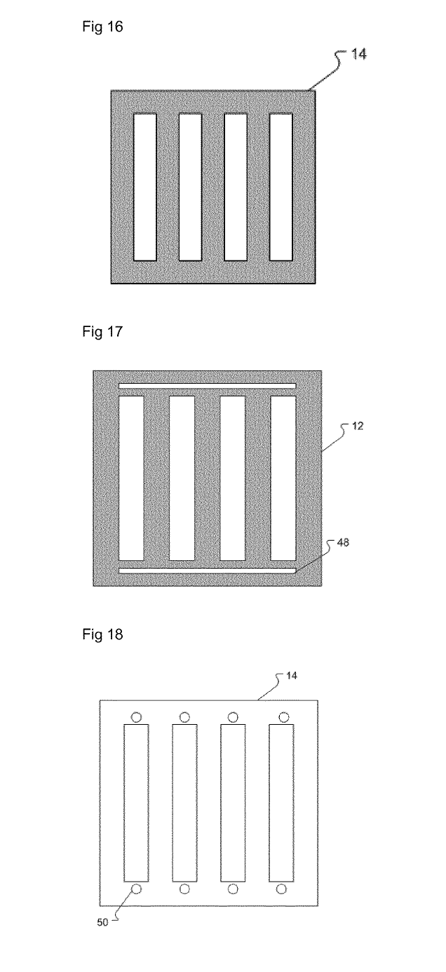

In addition to preventing the switch from overshooting in the direction of motion, it may be necessary to keep the alignment of the switch in the direction perpendicular to the motion. FIG. 13 shows an embodiment of internal alignment pin holes formed along the perimeter of the non-moving part A, 12. Unlike the previously discussed internal pin holes that act as stoppers, these pin holes are designed to hold pins that prevent the moving parts from coming out of alignment in a direction perpendicular to the movement of the moving part B, 14, shown in FIG. 14. The overlap between the gray, high conductivity, parts should ideally be as small as possible in the ‘off’ state. FIG. 15 shows an example of external bumpers such as 42 mounted external to the switch to restrain the moving part 14 of FIG. 16 perpendicular to the direction of movement 36.

Any of the pins or bumpers discussed above may consist of many different types of materials, depending upon the desired properties. Pins may be of any material, including ceramics, polymers or glass, among many other materials. They may need to have a particular rigidity to allow for better anchoring and control of motion. Alternatively, they may consist of materials that can absorb some energy from the actuation, or have a coating of such a material. Of course, if the actuator has the intrinsic capability of controlling the position and extent of the motion, the bumpers and pins may not be necessary.

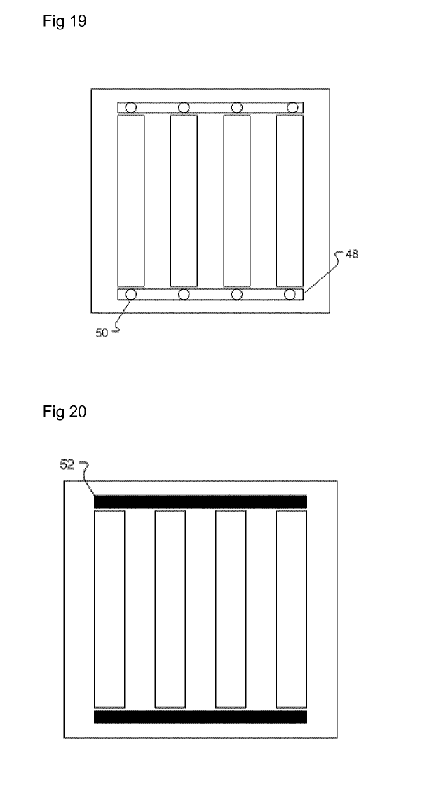

In one embodiment, shown in FIGS. 17-19, the restraint may comprise a groove or set of grooves, such as 48 in the non-moving part A 12. FIG. 17 shows an example of such a groove. The moving part B, 14, shown in FIG. 18, may have spheres 50 of some sort positioned to align with the grooves. The grooves may have rectangular, trapezoidal, or triangular cross sections. Small spheres, possibly manufactured of sapphire, with diameters in the range of 1 to 20 micrometers may reside in the grooves or be affixed to the moving part with epoxy or other adhesive. This may serve to both restrict the motion of the switch to the appropriate path as well as control spacing between the two structures. The combination of the two structures is shown in FIG. 19, with the spheres 50 residing in the grooves 48. Alternatively, raised rails may exist on one part such as rails 52 shown in FIG. 20. The raised rails mate with the grooves such that the rails or grooves move relative to the other. The spheres may have an advantage in that they have relatively low contact area with the associated addition thermal conductance. Other means of constraining the motion of the heat switches are also possible.

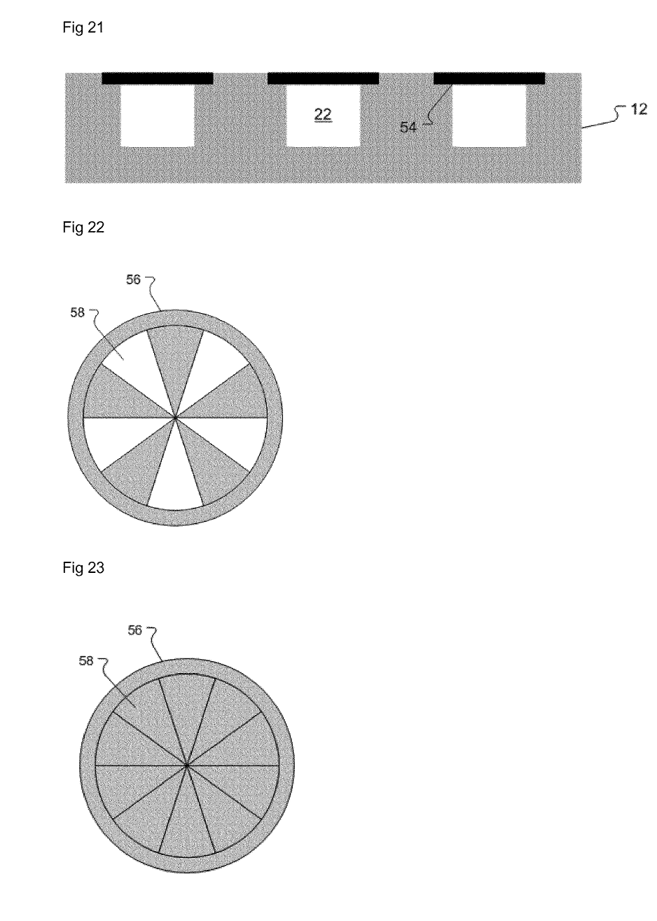

Many other variations exist. As mentioned previously, the material with low thermal conductivity may consist of a gas or a vacuum. In these embodiments, a cap 54 may seal off the chamber in which the low thermal conductivity resides, as shown in FIG. 21. The part may be 12 or 14 with the low thermal conductivity regions 22. The capping layer would function best as a low thermal conductivity material. It may also provide support for the lubricant and provide a solid interface in the off position. One issue that may arise otherwise with air or a gas without the capping layer is that in the off position, the fingers of high thermal conductivity material may encroach into the low thermal conductivity area. The actuator may control this, or the capping layer may prevent this encroachment.

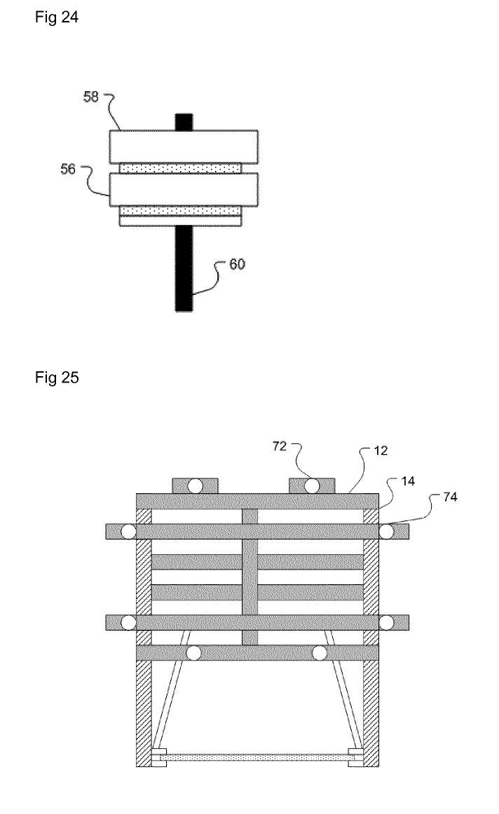

Up to this point, the discussion has focused upon a linear thermal switch that moves from one side to the other to align the thermally conductive regions on the two structures of the switch. FIGS. 22-24 show an embodiment with a rotary actuation. FIG. 22 shows a top view of two structures mounted in a rotational structure. As shown in FIG. 22, the wheel or disk 56 may be slightly larger than the disk at the top of the structure 58. The rotary structure in FIG. 22 has the darker regions being the regions with high thermal conductivity and the white regions being the low thermal conductivity regions. In FIG. 23, the moving disk has been rotated such that the low thermal conductivity regions on the underside disk are now aligned with the high thermal conductivity regions, essentially covering the openings and presenting as a solid disk. FIG. 24 shows a side view of a rotational embodiment. The actuator in this embodiment will typically consist of an axle such as 60 attached to the moving disk to provide it with the power to move.

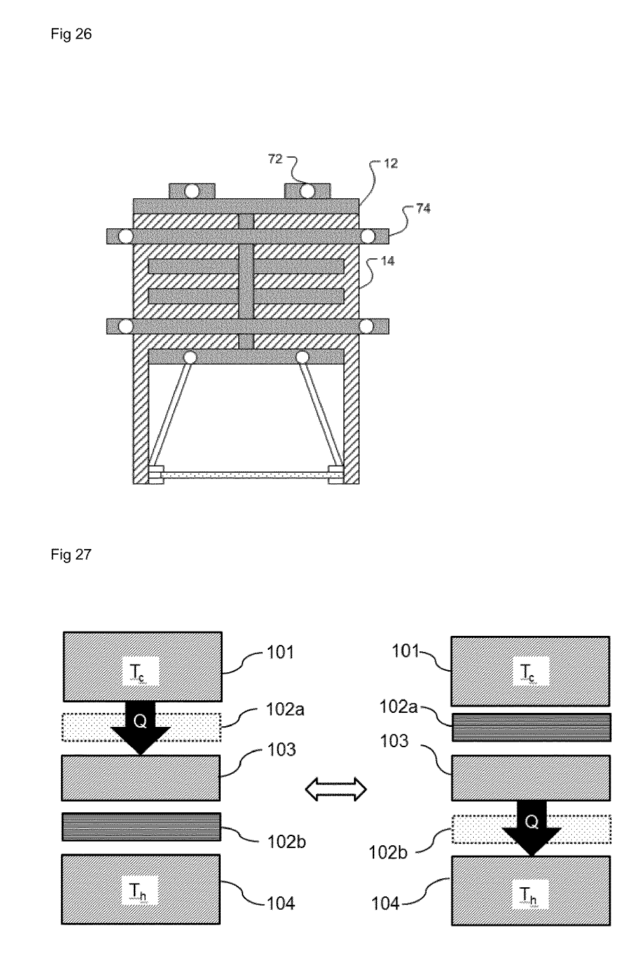

FIGS. 25-26 show an embodiment of a complete thermal switch having both alignment pins 74 and stopper pins or bumpers 72. The moving part 14 is positioned in FIG. 25 in such a matter that the high thermal conductivity regions are aligned with those on the non-moving part 12. In FIG. 26, the regions are no longer aligned.

In operation, the heat switch controller or actuator may respond to an electrical signal initiated by a switch, pushbutton or otherwise, an electronic control such as a thermostat, or a computer control, as examples. Upon reception of the signal, the actuator moves the moving part of the heat switch into either the on or off position. The translation of the moving part then either creates a high thermal conductivity path or not.

In some embodiments, the heat switch may have additional features to enhance its functionality. These may include sensors, such as temperature sensors, such as thermistors, thermocouples, resistance temperature detectors, etc. Other sensors may include force and pressure sensors, position sensors, timers, etc. These sensors may provide inputs to the actuators controller to aid in accurately controlling the position, preventing wear, enhancing lifetime, improving system level performance, or provide other benefits.

The heating and cooling enabled by the use of the heat switch may include many different types of heating and cooling. These include variable insulation, selective heating or cooling, or as part of an electrocaloric, magnetocaloric, or other heat pumping or cooling system.

In this manner, a mechanical heat switch is provided that has a relatively simple manufacturing process, good thermal contrast and ease of actuation. In one experiment, a heat switch with an area of approximately 1 cm², with a conductance of 1.2 W/K in the on state and 0.027 W/K in the off state. This gives a thermal contrast ratio of 1.2/0.027=44.

The experimental heat switch was fabricated from flat silicon wafers of thicknesses ranging from 200 micrometers to 650 micrometers. Grooves were created using reactive ion etching. Heat switch parts were combined with a layer of low viscosity silicone oil to allow low-friction motion. Alignment of separate heat switch parts was accomplished with an experimental fixture with precise control in six degrees of freedom. Heat switch performance was measured by thoroughly insulating the device, providing heat with a thin film heat source, and measuring temperature differences using calibrated thermistors. In a separate experiment, self-aligned heat switches, also fabricated from flat silicon wafers using reactive ion etching, were tested. These heat switches used glass capillaries as stoppers and alignment pins. Performance measurements were carried out with a similar technique.

A further object is a cooling or heating device comprising at least one heat switch as described above. The cooling or heating device usually comprises one or more materials showing a transition when an external field is applied thereby generating or consuming heat. Such materials are called transition materials hereinafter. Examples of such transition materials are magnetocaloric (MC) and electrocaloric (EC) materials. In a material which exhibits a magnetocaloric effect, the alignment of randomly oriented magnetic moments by an external magnetic field leads to heating of the material. This heat can be released by the MC material into the surrounding atmosphere by a heat transfer. When the magnetic field is then switched off or removed, the magnetic moments revert back to a random alignment, which leads to cooling of the material below ambient temperature. Magnetocaloric materials are for example described in WO 2009/133049 A1. The electrocaloric effect is the ability of certain materials to increase or decrease in temperature when exposed to an applied electric field. Electrocaloric cooling and heating devices are described for example in US 2015/0082809 A1. Materials with large EC effect include ferroelectric ceramics and polymers, see for example H. Chen, T.-L. Ren, X.-M Wu, Y. Yang, & L.-T Liu, Appl. Phys. Lett., 94, 182902 (2009) and X. Li, S.-G. Lu, X.-Z Chen, H. Gu, X.-S. Qian, & Q. M. Zhang, Journal of Materials Chemistry C, 1, 23-37. (2013). In a heat-switch-based electrocaloric cooling or heating device the heat flux to and from an electrocaloric (EC) material which is exposed to variable electric fields is controlled by heat switches. A possible way to apply electric fields to the EC materials is the use of capacitors with EC material forming an EC module. Such EC modules are commercially available, e.g. BaTiO₃ multilayer capacitors composed of BaTiO₃ dielectric material and Ni-electrodes from AVX Corporation, USA. Preferred transition materials are electrocaloric and magnetocaloric materials.

A scheme of the operation principle of a heat switch based electrocaloric cooling system is shown in FIG. 27. T_{c} denotes the cold side (101), Tₕ the hot side (104) of the cooling device. The device comprises two heat switches 102a and 102b and an electrocaloric (EC) module 103 containing at least one EC material. On the left hand side of FIG. 27 heat switch 102a is on and heat flow (Q) from the cold side to the electrocaloric module 103 is enabled. Heat switch 102b is off. The EC module 103 is at zero electric field. In the next step of the cooling cycle heat switch 102b is opened, the electric field is turned on and heat switch 102a is closed. This stage is shown on the right hand side of FIG. 27. The applied electric field causes an adiabatic polarization of the EC material leading to a temperature increase. The heat (Q) generated by the adiabatic polarization is partly transferred from the EC module 103 to the hot side of the cooling system via heat switch 102b. In the last step of the cooling cycle the electric field is turned off leading to a temperature decrease in the EC module below Tc while heat switch 102a is opened and heat switch 102b is closed. Instead of using EC materials it is also possible to use other transition materials, e.g. one or more magnetocaloric materials. In case of MC materials a varying magnetic field has to be applied to induce magnetization/demagnetization of the MC material.

The cooling or heating device may be partially or completely thermally insulated to minimize undesired heat flow from or to the device or parts of the device. Undesired heat flow may occur for example between the cool side of the device and the environment and/or between the cool side and the hot side of the device. Insulation may be effected e.g. by applying one or more layers of thermally insulating material like polymer foams around the device or parts of it. This is especially advantageous in case the device is used for cooling purposes.

The cooling or heating device may comprise one heat switch, two heat switches or three and more heat switches. The at least one heat switch is usually thermally connected to one or more transition materials to allow thermal flux through the heat switch depending on the operational modus of the heat switch, i.e. depending on whether the heat switch is in on (open) or off (closed) position.

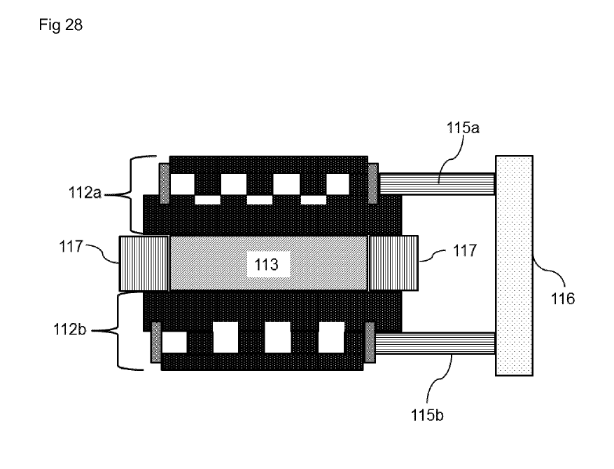

The transition material(s) and the heat switches may be arranged differently within the electrocaloric cooling or heating device. For example the transition material(s) and the heat switches may form a layered structure, e.g. a layer comprising a transition material and optionally additional means for applying a varying field to the material arranged between two heat switches. An example for such arrangement is shown schematically in FIG. 28 for an EC cooling device. An EC module 113 comprising EC material and electrodes for applying an electrical field to the EC material is positioned between two heat switches 112a and 112b. In principle the heat switches may have any suitable form as described herein. According to the embodiment shown in FIG. 28 the heat switches 112a and 112b are similar to the heat switches as shown in FIGS. 6 and 7. The EC module is surrounded at the edges by thermal insulations 117. In the embodiment shown in FIG. 28 each heat switch has a handle 115a and 115b which are attached to an actuator 116. The heat switches 112a and 112b are identical except for the bottom parts, in which the fingers composed of the material having lower thermal conductive materials are offset so that when the center parts are in the same horizontal position, one heat switch is closed and the other is open. In this embodiment both handles can be moved simultaneously thereby opening and closing heat switches 112a and 112b alternatingly. It is also possible to connect the handles independently from each other to one or more actuators allowing independent opening and closing of the heat switches. The handles 115a and 115b may be made of a thermally low conductive material such as glass or a suitable polymer with low thermal conductivity.

The cooling or heating device may be used in cooling applications like refrigeration and air conditioning and as heat pump. The cooling or heating device is preferably a refrigerator, an air conditioning system or a heat pump. The cooling or heating device is preferably an electrocaloric or a magnetocaloric cooling device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A heat switch, comprising:
a first structure having alternating fingers of first and second materials, wherein the first material has a higher thermal conductivity than the second material;
a second structure having alternating fingers of third and fourth materials, positioned adjacent the second structure such that the second structure selectively contacts the first structure; and
an actuator connected to one of the first and second structures such that when the actuator is activated, at least the second structure moves relative to the other of the first and second structures.

2. The heat switch of claim 1, further comprising:
a layer of lubricant between the first and second structure, the layer of lubricant in contact with at least a portion of the first and second structures.

3. The heat switch of claim 1, wherein the first and third materials are a first same material, and the second and fourth materials are a second same material.

4. The heat switch of claim 1, further comprising:
a support to which the first structure is attached.

5. The heat switch of claim 4, wherein the support comprises the first material.

6. The heat switch of claim 1, further comprising:
a fixed structure that does not move relative to the first structure, the second structure arranged to move between the fixed structure and the first structure.

7. The heat switch of claim 1, further comprising:
a restraint structure positioned to limit motion of the second structure.

8. The heat switch of claim 7, wherein the restraint structure comprises a restraint structure positioned parallel to a direction of motion of the second structure.

9. The heat switch of claim 7, wherein the restraint structure comprises a restraint structure positioned perpendicular to a direction of motion of the second structure.

10. The heat switch of claim 7, wherein the restraint structure comprises one of pins, bumpers, or grooves combined with one of spheres and raised rails.

11. The heat switch of claim 7, wherein the restraint structure is internal or external to the first and second structures.

12. The heat switch of claim 1, wherein the actuator comprises one of a linear motor, a voice coil, a piezoelectric actuator, or a stepper motor.

13. The heat switch of claim 1, wherein the second structure is positioned to move linearly relative to the first structure.

14. The heat switch of claim 1, wherein the second structure is positioned to move rotationally to the first structure.

15. The heat switch of claim 1, wherein the heat switch is adapted to function in conjunction with one of either an electrocaloric cooling system or a magnetocaloric cooling system.

16. A method of manufacturing a heat switch, the method comprising:
forming a first structure in a first material, the first structure having fingers at least partially separated from each other by gaps;
forming a second structure in the first material, the second structure having fingers at least partially separated from each other by gaps;
positioning the first and second structure adjacent to and in contact with each other; and
connecting the second structure to an actuator.

17. The method of claim 16, wherein the first material comprises at least one of silicon, copper, aluminum, metal, semi-metals, semiconductors, ceramics, boron nitride, aluminum nitride, and diamond.

18. The method of claim 16, further comprising:
filling the gaps in the first and second structures with a second material, the second material having a lower thermal conductivity than the first material.

19. The method of claim 18, wherein filling the gaps in the first and second structures with a second material comprises filling the gaps with at least one of a solid, liquid, gas, air, vacuum, porous silicon, epoxy, porous epoxy, polyimide, polyurethanes, porous polyurethanes, aeorgels and photoresist.

20. The method of claim 16, further comprising:
forming a vacuum in the gaps.

21. The method of claim 18, wherein filling the gaps comprises applying a curable liquid to the gaps in the first and second structures.

22. The method of claim 21, wherein applying a curable liquid comprise treating surfaces of the first material in the first and second surfaces with a wetting coating.

23. The method of claim 16, further comprising:
applying a lubricant between the first and second structures.

24. The method of claim 23, comprising lubricating at least one of the first and second structures by applying a layer of one of silicon oil, mineral oils, ethylene glycol, and liquids with loading of solid microspheres comprising one of polystyrene and silver.

25. A method of operating a heat switch having two structures, the method comprising:
receiving an activation signal at an actuator; and
moving a first structure of the heat switch relative to a second structure of the heat switch with the actuator to change alignment between two regions of different thermal conductivity,
wherein the first and second structures have regions of different thermal conductivity.

26. The method of claim 25, wherein the receiving comprises receiving a signal from one of a switch, an electronic control and a computer.

27. The method of claim 25, wherein the moving comprises moving a linear motor, a voice coil, a piezoelectric actuator, or a stepper motor.

28. A cooling or heating device, comprising at least one heat switch of claim 1.
